(19) United States
(12) Patent Application Publication
(10) Pub. No.: US 2019/0176405 A1
(43) Pub. Date: Jun. 13, 2019

(54) COMPUTER AIDED DESIGN WITH HIGH RESOLUTION LATTICE STRUCTURES USING GRAPHICS PROCESSING UNITS (GPU)

(71) Applicant: SIEMENS PRODUCT LIFECYCLE MANAGEMENT SOFTWARE INC., Plano, TX (US)

(72) Inventors: George Allen, Okinawa (JP); Suraj Ravi Musuvathy, Princeton, NJ (US)

(21) Appl. No.: 16/321,893

(22) PCT Filed: Aug. 11, 2017
(86) PCT No.: PCT/US2017/046539

§ 371 Date: Jan. 30, 2019

Related U.S. Application Data
(60) Provisional application No. 62/374,353, filed on Aug. 12, 2016.

(51) Int. Cl. B29C 64/393; G06T 17/20; G06F 17/50; G06T 15/00; B33Y 10/00; B33Y 50/02

(52) U.S. Cl. CPC B29C 64/393; G06T 17/20; B33Y 50/02; G06T 15/005; B33Y 10/00; G06F 17/50

(57) ABSTRACT

A system and method for processing information of a high resolution lattice relating to computer aided design application includes in a first computer processor, tessellating the part surfaces and copying them to a memory associated with a graphics processing unit (GPU). Further processing based on rods is performed on a processor associated with the GPU, wherein processing tasks are subdivided and performed in parallel in a plurality of processing cores of the GPU. Each subdivided processing task may be performed in a separate processing thread allocated to the subtask. The GPU processor produces output based on the further processing and copies the output information to the first computer processor. The first computer processor may perform further processing to the output provided by the GPU.

### TECHNICAL FIELD

This application relates design and manufacture of objects. More particularly, the application relates to computer aided design and manufacture of objects using additive manufacturing.

### BACKGROUND

Lattice structures are repeated arrangements of strut-like shapes in a grid-like pattern that approximate a solid volume. Products produced from lattices demonstrate advantages in high structural strength with lower mass, and exhibit enhanced cooling, vibration/acoustic/shock energy damping, orthopedic implant bio-integration. Therefore, these products are highly desirable across several applications spanning aerospace, automotive, power generation, industrial machinery and healthcare. A part with a volume of roughly one cubic meter (m³) having a lattice resolution of 1 cubic millimeter (mm³) will contain on the order of one billion lattice struts. Computer aided design (CAD) modeling of such high resolution lattice structures containing hundreds of millions to billions of lattice struts, is extremely computationally demanding. New methods are desired to enable interactive modeling with such high resolution lattices.

Lattice modeling in commercial CAD systems has typically been done using native boundary representation (BRep) CAD functionally. Such methods are computationally demanding and labor intensive. Independent commercial applications for lattice modeling exist but are not integrated with CAD systems thereby limiting their use in typical design processes. Polygonal based modeling, implicit surface based modeling, and procedural modeling techniques have been presented in the academic literature. These techniques do not address high resolution lattices, containing millions, or even billions, of lattice struts or elements.

### SUMMARY

According to aspects of embodiments described below, a computerized method of processing information in a high resolution lattice associated with a computer aided design (CAD) application includes in a first processor of a host computing device, determining a plurality of vertices representative of the part surfaces, and sending the plurality of vertices to a memory associated with a second processor of a graphics processing unit (GPU). The second processor subdivides processing tasks relating to the plurality of rays oriented along sets of rods in the lattice and processes the subdivided processing tasks in parallel.

According to aspects of embodiments of this disclosure the second processor generates output information from the processing of the subdivided processing tasks; and copies the output information to a memory associated with the first processor of the host computing device.

According to aspects of some embodiments the output information is related to mass properties of an object represented by the high resolution lattice.

According to aspects of some embodiments the output information is related to generating a slice of an object represented by the high resolution lattice.

According to aspects of some embodiments the first processor performs additional processing on the output information generated by the second processor.

According to aspects of some embodiments the additional processing computes tool paths for a tool of an additive manufacturing process.

According to aspects of some embodiments the first processor is adapted to compute the tool paths as G-code.

According to aspects of some embodiments the first processor is a central processing unit of the host computing device.

According to aspects of some embodiments the GPU computer processor is a GPU processor having a plurality of processing cores.

According to aspects of some embodiments the second computer processor is adapted to process information in the plurality of processing cores in parallel via a plurality of processing threads.

In a system according to aspects of embodiments described below includes a first computer processor, a first memory in communication with the first computer processor; and a graphics processing unit (GPU), the GPU including a GPU processor comprising a plurality of processing cores and a memory in communication with the GPU processor. A set of computer executable instructions are stored in the first memory, and when executed by the first computer processor cause the first computer processor to determine a plurality of vertices representative of the part surfaces within which the high resolution lattice is contained, sending the plurality of vertices to a memory associated with a second processor, wherein the second processor is a processor of a graphics processing unit (GPU).

The set of computer executable instructions are further executable on the GPU processor, and when executed on the GPU processor cause the GPU processor to subdivide processing tasks relating to the plurality of rays oriented along sets of rods in the lattice and process the subdivided processing tasks in parallel.

According to aspects of some embodiments the set of computer executable instructions, further cause the GPU processor to perform the steps of generating output information from the processing of the subdivided processing tasks and copying the output information to the first memory associated with the first computer processor.

According to aspects of some embodiments the output information is related to mass properties of an object represented by the high resolution lattice.

According to aspects of some embodiments the output information is related to generating a slice of an object represented by the high resolution lattice.

According to aspects of some embodiments the first computer processor performs additional processing on the output information generated by the GPU processor.

According to aspects of some embodiments the additional processing computes tool paths for a tool of an additive manufacturing process.

According to aspects of some embodiments the first computer processor is adapted to compute the tool paths as G-code.

In other embodiments, the first processor is a central processing unit of the host computing device.

According to aspects of some embodiments the set of computer executable instructions, further comprise instructions that when executed by a processor cause the first computer processor to tessellate part surfaces to create a triangle mesh representation of the part surfaces, copy vertices of the triangles in the triangle mesh to a memory of the GPU. The instructions further cause the GPU processor to instantiate a a set of rays aligned with the lattice rods orientations, allocate one of a plurality of processing threads of the GPU to each ray in the set of rays, distribute the allocated processing threads evenly into a plurality of thread blocks, compute the portions of each ray that lie within the part surfaces, compute the mass properties of the rods and spheres along those portions, and accumulate the result to the memory in communication with the first computer processor.

According to aspects of some embodiments the set of computer executable instructions, further comprise instructions that when executed by a processor cause the first computer processor to tessellate part surfaces to create a triangle mesh representation of the part surfaces, copy vertices of the triangles in the triangle mesh to a memory of the GPU. The instructions further cause the GPU processor to determine a set of rod segments of the lattice structure that intersect a first slicing plane and inside the part surfaces, allocate one of a plurality of processing threads of the GPU to each rod in the set of rod segments intersecting the first slicing plane, distribute the allocated processing threads evenly into a plurality of thread blocks, compute an intersection curve for each rod segment intersecting the first slicing plane based on a triangle mesh representation of each rod segment in a local neighborhood of the slice plane and copy the computed intersection curves to the memory in communication with the first computer processor. The executable instructions may further include instructions to cause the first computer processor to compute two-dimensional Boolean unions of each of the intersection curves on the slicing plane to extract edge curves.

In another representative embodiment, a method for fabricating a part using additive manufacturing based on a high resolution lattice structure includes in a first computer processor, tessellating part surfaces to create a temporary triangle mesh representation of the part and transferring vertices of triangles in the triangle mesh to a second processor of a graphics processing unit. In the GPU, intersection curves for a plurality of rod segments of the triangle mesh are calculated, wherein the plurality of rod segments intersect a first slicing plane of the object, wherein each of the plurality of rod segments is processed in a separate thread of the GPU processor. The calculated intersection curves are transferred to the first computer processor; and the first computer processor performs two-dimensional Boolean unions on the intersection curves of the first slicing plane and computes tool paths on the first slicing plane and creating G-code for input to a computerized tool.

### BRIEF DESCRIPTION OF THE DRAWINGS

The foregoing and other aspects of the present invention are best understood from the following detailed description when read in connection with the accompanying drawings. For the purpose of illustrating the invention, there is shown in the drawings embodiments that are presently preferred, it being understood, however, that the invention is not limited to the specific instrumentalities disclosed. Included in the drawings are the following Figures:

FIG. 1 is an illustration of a lattice structure comprising rods and spherical connectors between rods according to aspects of embodiments of the disclosure.

FIG. 2 is a process flow diagram illustrating a process of calculating mass properties (e.g., surface area, volume, mass in a lattice representation of an object according to aspects of embodiments of the disclosure.

FIG. 3 is a process flow diagram illustrating a method of slicing a three-dimensional object represented in a high resolution lattice structure according to aspects of embodiments of the disclosure.

FIG. 4 is a block diagram of a computing system capable of leveraging the parallel computing power of a GPU according to aspects of embodiments of this disclosure.

FIG. 5 is a block diagram of a computing system which may perform aspects of embodiments of this disclosure.

### DETAILED DESCRIPTION

Various aspects of the present invention relate to a rod lattice representation defined by an arrangement of generalized cylindrical rods with optional spherical balls at the rod junctions. The shapes and cross-section sizes of the rods can be constant or defined by some function. The rod arrangements could be aligned according to a coordinate system that could be axis-aligned, cylindrical or spherical.

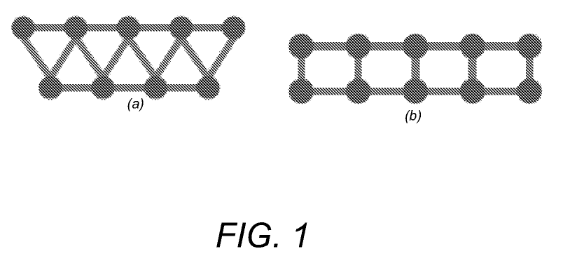

FIG. 1 illustrates examples of an object mesh represented by a set of rods and spheres at intersections of the rods. Rods may be arranged to define geometric shapes. The geometric shapes may include corrugated triangles (example (a)) or cubic shapes (example (b)) may be used.

Aspects of the present invention relate to a new approach for designing parts with high resolution lattice structures using algorithms that leverage the massive parallel computing power of graphics processing units (CPUs). The lattice itself is defined with a small set of parameters such as rod density (number of rods in a given direction), rod layout coordinate system (axis-aligned, cylindrical, etc.), and rod thicknesses. Algorithms are presented for representative and critical modeling operations required for designing and manufacturing parts with lattices using GPUs. In particular, GPU methods for computing mass properties and slicing are presented.

The processing abilities of GPUs may be accessed via interfaces such as CUDA and OpenCL among others. The computing application may be programmed according to an Application Programming Interface (API) specific to the GPU interface, which provides the desired programmed functionality to the CPU's parallel computing architecture. While a conventional CPU may have multiple processing cores (e.g. 1 to 12 cores), a GPU may include hundreds of smaller processing cores. This allows large programming task to be sub-divided and distributed among multiple parallel processing threads, each being processed in one of the processing cores.

Instead of creating the surfaces of all the lattice rods, aspects of the present disclosure are adapted to compute certain relevant information when required using reduced order or locally instantiated representations of the rods in a parallel manner.

For example, when the mass properties of a part with a lattice are desired, the corresponding algorithm may be invoked utilizing GPUs to compute and present the mass property values to the user without using an instantiated representation of the lattice. Mass property calculation on a GPU is accomplished by independently computing mass properties of individual rods in a parallel manner and then aggregating the individual values together.

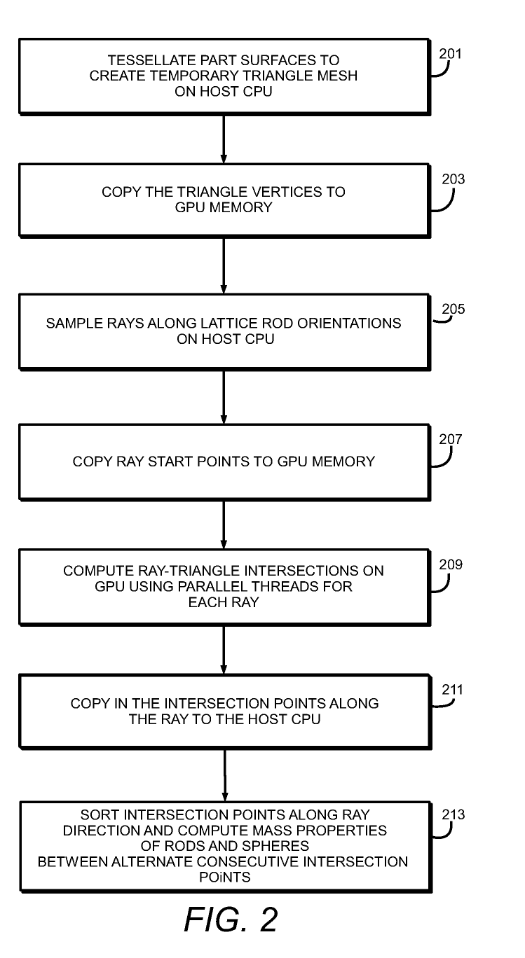

FIG. 2 is a process flow diagram for computing mass properties of a lattice within a part with the assistance of a GPU according to aspects of embodiments of this disclosure. First, part surfaces are tessellated to create a temporary mesh representation on a host CPU 201. The vertices of the resulting triangles representing the surface of the mesh are then copied to memory associated with the GPU 203. Ray start points are sampled along lattice rod orientations with the processing being performed in the CPU 205. The sampled rays start points are then copied to the memory of the GPU 207.

In a parallel manner, the GPU processing cores compute intersection points where each ray intersects the triangles defined by the vertices representing the surface of the object mesh. Each ray is processed in an associated processing thread 209. Each thread checks for intersections of a single ray with all the triangles. The start points are evenly distributed into thread blocks. Alternatively, a thread performs an intersection of a single ray with a single triangle, and a thread is instantiated for every ray-triangle pair. In intersection points (distance along ray) are copied onto memory in communication with the host CPU 211. When the intersection points for each of the rays are computed and copied back to the host CPU, the intersection points may be sorted along the ray direction and mass properties of the rods between alternative consecutive intersection points are calculated 213.

Rendering the lattice gives a designer key visual insight into the form of the part. However, for high resolution lattices, it may be unnecessary to visualize all the rods since they are very close to each other. Therefore, an abstract representation of the lattice within a viewing volume may be shown to indicate the presence of a lattice.

During additive manufacturing, an object is divided into slices. Each slice is then fabricated by way of a 3D printer or other manufacturing means, that produces structures contained in the slice. Once a slice is completed, the 3D printer will begin constructing an adjacent slice. Slices are completed sequentially until the entire object has been fabricated.

In order to fabricate the part with the lattice, the first step is to compute intersections of the lattice with slice planes, with each slice representing a layer of material to be deposited or formed.

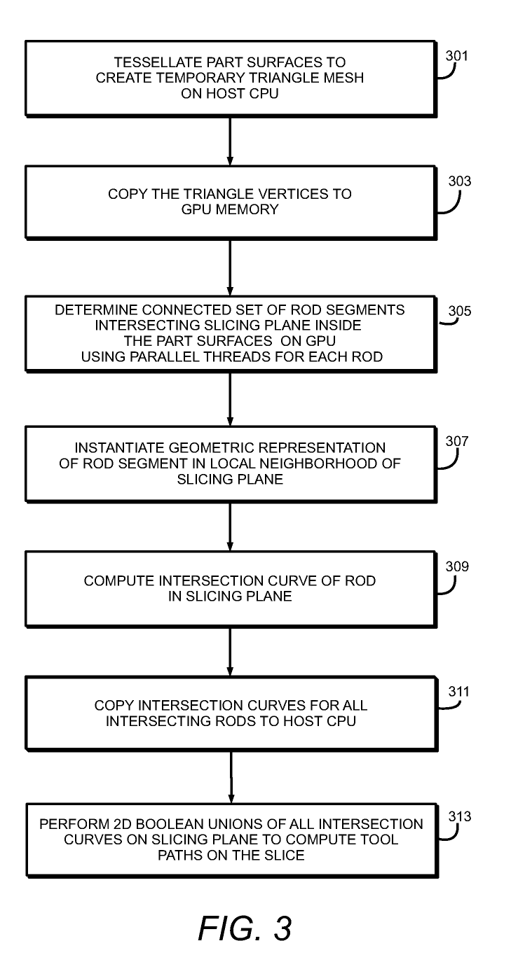

FIG. 3 is a process flow diagram according to aspects of the embodiments of this disclosure where GPUs can be used to efficiently and quickly compute a single slice by parallelizing the operation as follows:

The part surfaces are tessellated to create temporary triangle mesh representation on the host CPU 301. The vertices of the triangles representing the object surface are copied to memory associated with the GPU 303. A connected set of rod segments that intersect a slicing plane of interest and within the region bounded by part surfaces is determined and a thread is instantiated for every rod segment 305. A rod segment is deemed to be intersecting the slice plane if the rod's end points are on opposite sides of the plane, or if one of the rod's end points is closer to the slicing plane than the rod radius. The threads for the rod segments may be evenly distributed into thread blocks.

For each intersecting segment, a geometric representation of the rod segment in the local neighborhood of the slicing plane is instantiated 307. Then the intersection curve of the rod with the plane is computed on GPU 309. A thread is instantiated for every segment and is evenly distributed into thread blocks. An intersection curve for each rod segment is computed using parallel processing threads, where each thread is allocated to one of the rod segments 309. The processing of the intersection curves is performed in parallel on the processing cores of the GPU. Once calculated on the GPU, the intersection curves for all rod segments intersecting the slicing plane are copied to the memory associated with the host CPU 311. In the host computer CPU, 2D Boolean unions of all intersection curves in the slicing plane are performed and used to compute tool paths to fabricate the slice 313. The tool paths may be instantiated as G-code instructions for controlling a tool in an industrial process, such as additive manufacturing.

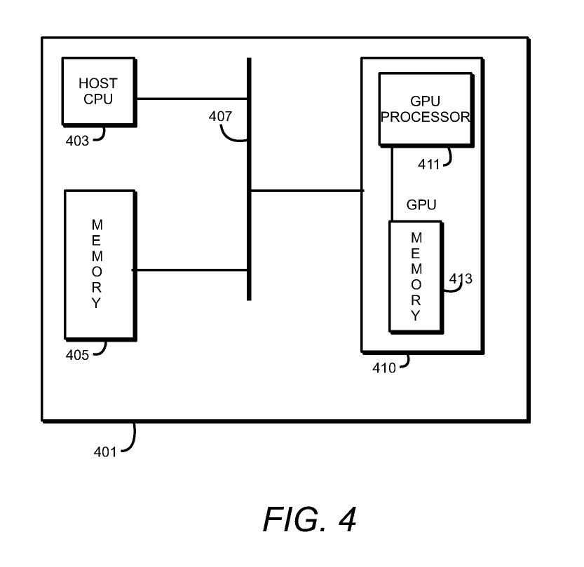

FIG. 4 is a high level block diagram of a system that is suitable for performing additive manufacturing pre-processing by leveraging parallel computing power of a GPU. A computing device 401 includes a host central processing unit (CPU) 403. The CPU 403 is in communication with a memory 405 via a communications bus 407. Communication bus 407 further connects a GPU 410 to processor 403 and memory 405. GPU 410 includes a GPU processor 411 which may contain hundreds of processing cores capable of processing data in parallel processing threads. GPU 410 may include onboard memory 413 in communication with GPU processor 411. Data may be processed in CPU 403 and transmitted along communication bus 407 to the GPU 410 for processing. The data may be subdivided into smaller tasks that may be distributed among parallel processing threads. Algorithms described in this disclosure allow for efficient processing of high resolution 3D object meshes for calculating properties relating to additive manufacturing. Computing device 401 may include other components than those shown in FIG. 4, these components have been omitted for clarity and to provide a better understanding of the embodiments described herein.

The ability of GPU 410 to process multiple operations in parallel provides the advantage in computer aided design to consider only relevant portions of the mesh lattice, rather than creating surfaces for all rods in the lattice. Computing only relevant information when required using reduced order or locally instantiated representations of the rods in a highly parallel manner, allows for processing of very high resolution lattice structures that may not otherwise be practicable by conventional CAD applications running on conventional CPUs.

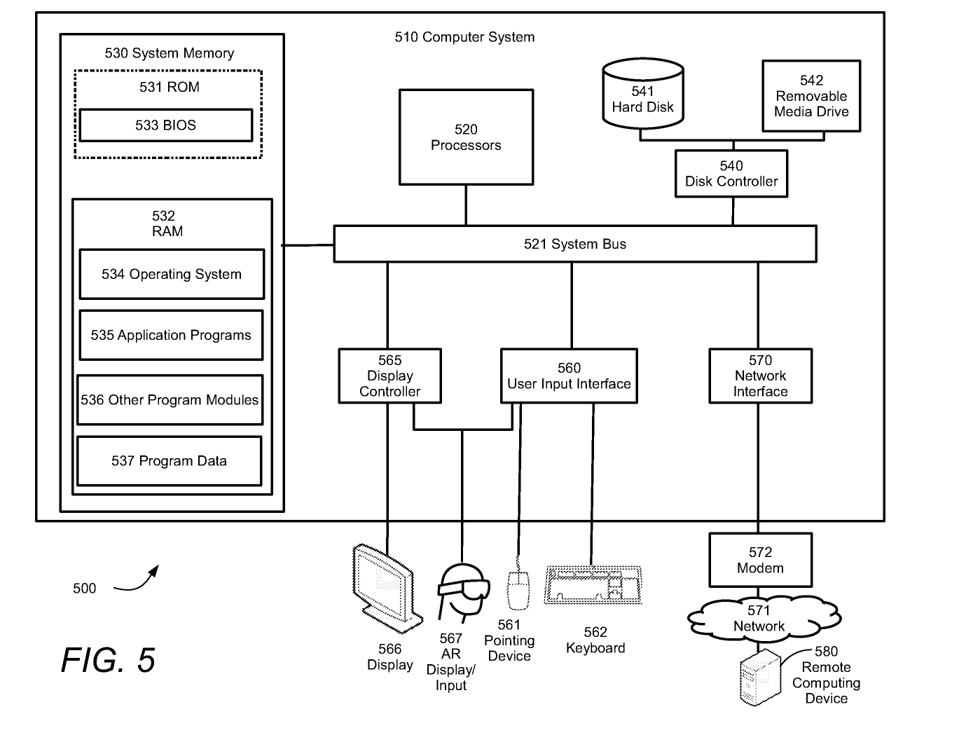

FIG. 5 illustrates an exemplary computing environment 500 within which embodiments of the invention may be implemented. Computers and computing environments, such as computer system 510 and computing environment 500, are known to those of skill in the art and thus are described briefly here.

As shown in FIG. 5, the computer system 510 may include a communication mechanism such as a system bus 521 or other communication mechanism for communicating information within the computer system 510. The computer system 510 further includes one or more processors 520 coupled with the system bus 521 for processing the information.

The processors 520 may include one or more central processing units (CPUs), graphical processing units (CPUs), or any other processor known in the art. More generally, a processor as used herein is a device for executing machine-readable instructions stored on a computer readable medium, for performing tasks and may comprise any one or combination of, hardware and firmware. A processor may also comprise memory storing machine-readable instructions executable for performing tasks. A processor acts upon information by manipulating, analyzing, modifying, converting or transmitting information for use by an executable procedure or an information device, and/or by routing the information to an output device. A processor may use or comprise the capabilities of a computer, controller or microprocessor, for example, and be conditioned using executable instructions to perform special purpose functions not performed by a general purpose computer. A processor may be coupled (electrically and/or as comprising executable components) with any other processor enabling interaction and/or communication there-between. A user interface processor or generator is a known element comprising electronic circuitry or software or a combination of both for generating display images or portions thereof. A user interface comprises one or more display images enabling user interaction with a processor or other device.

Continuing with reference to FIG. 5, the computer system 510 also includes a system memory 530 coupled to the system bus 521 for storing information and instructions to be executed by processors 520. The system memory 530 may include computer readable storage media in the form of volatile and/or nonvolatile memory, such as read only memory (ROM) 531 and/or random access memory (RAM) 532. The RAM 532 may include other dynamic storage device(s) (e.g., dynamic RAM, static RAM, and synchronous DRAM). The ROM 531 may include other static storage device(s) (e.g., programmable ROM, erasable PROM, and electrically erasable PROM). In addition, the system memory 530 may be used for storing temporary variables or other intermediate information during the execution of instructions by the processors 520. A basic input/output system 533 (BIOS) containing the basic routines that help to transfer information between elements within computer system 510, such as during start-up, may be stored in the ROM 531. RAM 532 may contain data and/or program modules that are immediately accessible to and/or presently being operated on by the processors 520. System memory 530 may additionally include, for example, operating system 534, application programs 535, other program modules 536 and program data 537.

The computer system 510 also includes a disk controller 540 coupled to the system bus 521 to control one or more storage devices for storing information and instructions, such as a magnetic hard disk 541 and a removable media drive 542 (e.g., floppy disk drive, compact disc drive, tape drive, and/or solid state drive). Storage devices may be added to the computer system 510 using an appropriate device interface (e.g., a small computer system interface (SCSI), integrated device electronics (IDE), Universal Serial Bus (USB), or FireWire).

The computer system 510 may also include a display controller 565 coupled to the system bus 521 to control a display or monitor 566, such as a cathode ray tube (CRT) or liquid crystal display (LCD), for displaying information to a computer user. The computer system includes an input interface 560 and one or more input devices, such as a keyboard 562 and a pointing device 561, for interacting with a computer user and providing information to the processors 520. The pointing device 561, for example, may be a mouse, a light pen, a trackball, or a pointing stick for communicating direction information and command selections to the processors 520 and for controlling cursor movement on the display 566. The display 566 may provide a touch screen interface which allows input to supplement or replace the communication of direction information and command selections by the pointing device 561. In some embodiments, an augmented reality device 567 that is wearable by a user may provide input/output functionality allowing a user to interact with both a physical and virtual world. The augmented reality device 567 is in communication with the display controller 565 and the user input interface 560 allowing a user to interact with virtual items generated in the augmented reality device 567 by the display controller 565. The user may also provide gestures that are detected by the augmented reality device 567 and transmitted to the user input interface 560 as input signals.

The computer system 510 may perform a portion or all of the processing steps of embodiments of the invention in response to the processors 520 executing one or more sequences of one or more instructions contained in a memory, such as the system memory 530. Such instructions may be read into the system memory 530 from another computer readable medium, such as a magnetic hard disk 541 or a removable media drive 542. The magnetic hard disk 541 may contain one or more data stores and data files used by embodiments of the present invention. Data store contents and data files may be encrypted to improve security. The processors 520 may also be employed in a multi-processing arrangement to execute the one or more sequences of instructions contained in system memory 530. In alternative embodiments, hard-wired circuitry may be used in place of or in combination with software instructions. Thus, embodiments are not limited to any specific combination of hardware circuitry and software.

As stated above, the computer system 510 may include at least one computer readable medium or memory for holding instructions programmed according to embodiments of the invention and for containing data structures, tables, records, or other data described herein. The term “computer readable medium” as used herein refers to any medium that participates in providing instructions to the processors 520 for execution. A computer readable medium may take many forms including, but not limited to, non-transitory, non-volatile media, volatile media, and transmission media. Non-limiting examples of non-volatile media include optical disks, solid state drives, magnetic disks, and magneto-optical disks, such as magnetic hard disk 541 or removable media drive 542. Non-limiting examples of volatile media include dynamic memory, such as system memory 530. Non-limiting examples of transmission media include coaxial cables, copper wire, and fiber optics, including the wires that make up the system bus 521. Transmission media may also take the form of acoustic or light waves, such as those generated during radio wave and infrared data communications.

The computing environment 500 may further include the computer system 510 operating in a networked environment using logical connections to one or more remote computers, such as remote computing device 580. Remote computing device 580 may be a personal computer (laptop or desktop), a mobile device, a server, a router, a network PC, a peer device or other common network node, and typically includes many or all of the elements described above relative to computer system 510.

When used in a networking environment, computer system 510 may include modem 572 for establishing communications over a network 571, such as the Internet. Modem 572 may be connected to system bus 521 via user network interface 570, or via another appropriate mechanism.

Network 571 may be any network or system generally known in the art, including the Internet, an intranet, a local area network (LAN), a wide area network (WAN), a metropolitan area network (MAN), a direct connection or series of connections, a cellular telephone network, or any other network or medium capable of facilitating communication between computer system 510 and other computers (e.g., remote computing device 580). The network 571 may be wired, wireless or a combination thereof. Wired connections may be implemented using Ethernet, Universal Serial Bus (USB), RJ-6, or any other wired connection generally known in the art. Wireless connections may be implemented using Wi-Fi, WiMAX, and Bluetooth, infrared, cellular networks, satellite or any other wireless connection methodology generally known in the art. Additionally, several networks may work alone or in communication with each other to facilitate communication in the network 571.

An executable application, as used herein, comprises code or machine readable instructions for conditioning the processor to implement predetermined functions, such as those of an operating system, a context data acquisition system or other information processing system, for example, in response to user command or input. An executable procedure is a segment of code or machine readable instruction, sub-routine, or other distinct section of code or portion of an executable application for performing one or more particular processes. These processes may include receiving input data and/or parameters, performing operations on received input data and/or performing functions in response to received input parameters, and providing resulting output data and/or parameters.

A graphical user interface (GUI), as used herein, comprises one or more display images, generated by a display processor and enabling user interaction with a processor or other device and associated data acquisition and processing functions. The GUI also includes an executable procedure or executable application. The executable procedure or executable application conditions the display processor to generate signals representing the GUI display images. These signals are supplied to a display device which displays the image for viewing by the user. The processor, under control of an executable procedure or executable application, manipulates the GUI display images in response to signals received from the input devices. In this way, the user may interact with the display image using the input devices, enabling user interaction with the processor or other device.

The functions and process steps herein may be performed automatically or wholly or partially in response to user command. An activity (including a step) performed automatically is performed in response to one or more executable instructions or device operation without user direct initiation of the activity.

The system and processes of the figures are not exclusive. Other systems, processes and menus may be derived in accordance with the principles of the invention to accomplish the same objectives. Although this invention has been described with reference to particular embodiments, it is to be understood that the embodiments and variations shown and described herein are for illustration purposes only. Modifications to the current design may be implemented by those skilled in the art, without departing from the scope of the invention. As described herein, the various systems, subsystems, agents, managers and processes can be implemented using hardware components, software components, and/or combinations thereof. No claim element herein is to be construed under the provisions of 35 U.S.C. 112, sixth paragraph, unless the element is expressly recited using the phrase “means for.”

1. A computerized method of processing information in a high resolution lattice associated with a computer aided design (CAD) application, comprising:
in a first processor of a host computing device, tessellating part surfaces to create a geometric representation of the part surface including rays sampled along lattice rod orientations;
copying the geometric representation to a memory associated with a second processor, the second processor being a processor of a graphics processing unit (GPU);
in the second processor, subdividing processing tasks relating to the plurality of rays; and
in the second processor, processing the subdivided processing tasks in parallel.

2. The method of claim 1, further comprising:
in the second processor, generating output information from the processing of the subdivided processing tasks; and
copying the output information to a memory associated with the first processor of the host computing device.

3. The method of claim 2, wherein the output information is related to mass properties of an object represented by the high resolution lattice.

4. The method of claim 2, wherein the output information is related to generating a slice of an object represented by the high resolution lattice.

5. The method of claim 2, further comprising:
in the first processor, performing additional processing on the output information generated by the second processor.

6. The method of claim 5, wherein the additional processing computes tool paths for a tool of an additive manufacturing process.

7. The method of claim 6, wherein the first processor is adapted to compute the tool paths as G-code.

8. The method of claim 1, wherein the first processor is a central processing unit of the host computing device.

9. The method of claim 1, wherein the second computer processor is a GPU processor having a plurality of processing cores.

10. The method of claim 8, wherein the second computer processor is adapted to process information in the plurality of processing cores in parallel via a plurality of processing threads.

11. A system for processing for processing information in a high resolution lattice associated with a computer aided design (CAD) application, comprising:
a first computer processor;
a first memory in communication with the first computer processor; and
a graphics processing unit (GPU) comprising:
a GPU processor comprising a plurality of processing cores; and
a memory in communication with the GPU processor;
a set of computer executable instructions stored in the first memory, which when executed by the first computer processor cause the first computer processor to:
tessellate part surfaces to create a geometric representation of the part surface including rays sampled along lattice rod orientations;
copy the geometric representation to a memory associated with a second processor, the second processor being a processor of a graphics processing unit (GPU);
wherein the set of computer executable instructions are further executable on the GPU processor, and when executed on the GPU processor cause the GPU processor to:
subdividing processing tasks relating to the plurality of rays; and
in the second processor, processing the subdivided processing tasks in parallel.

12. The system of claim 11, wherein the set of computer executable instructions, further cause the GPU processor to perform the steps of:
generating output information from the processing of the subdivided processing tasks; and
copying the output information to the first memory associated with the first computer processor.

13. The system of claim 12, wherein the output information is related to mass properties of an object represented by the high resolution lattice.

14. The system of claim 12, wherein the output information is related to generating a slice of an object represented by the high resolution lattice.

15. The system of claim 12, further comprising:
in the first processor, performing additional processing on the output information generated by the GPU processor.

16. The system of claim 15, wherein the additional processing computes tool paths for a tool of an additive manufacturing process.

17. The system of claim 16, wherein the first computer processor is adapted to compute the tool paths as G-code.

18. The method of claim 1, wherein the first processor is a central processing unit of the host computing device.

19. The system of claim 11, wherein the set of computer executable instructions, further comprise instructions that when executed by a processor cause:
the first computer processor to:
tessellate part surfaces to create a triangle mesh representation of the part surfaces;
copy vertices of the triangles in the triangle mesh to a memory of the GPU; and
the GPU processor to:
determine a set of rod segments of the lattice structure that intersect a first slicing plane and lie within a region bounded by the part surfaces;
allocate one of a plurality of processing threads of the GPU to each rod in the set of rod segments intersecting the first slicing plane;
distribute the allocated processing threads evenly into a plurality of thread blocks;
compute an intersection curve for each rod segment intersecting the first slicing plane based on a triangle mesh representation of each rod segment in a local neighborhood of the slice plane;
copy the computed intersection curves to the memory in communication with the first computer processor; and
cause the first computer processor to compute two-dimensional Boolean unions of each of the intersection curves on the slicing plane to extract edge curves.

20. A method for fabricating a part using additive manufacturing based on a high resolution lattice structure comprising:
in a first computer processor, tessellating part surfaces to create a temporary triangle mesh representation of the part;
transferring vertices of triangles in the triangle mesh to a second processor of a graphics processing unit (GPU);
calculating in the GPU processor, intersection curves for a plurality of rod segments of the triangle mesh,
wherein the plurality of rod segments intersect a first slicing plane of the object, wherein each of the plurality of rod segments is processed in a separate thread of the GPU processor;
transferring the calculated intersection curves to the first computer processor; and
in the first computer processor, performing two-dimensional Boolean unions on the intersection curves of the first slicing plane and that lie within a region bounded by surfaces of the part; and
in the first computer processor, computing tool paths on the first slicing plane and creating G-code for input to a computerized tool.
